(19) United States
(12) Patent Application Publication
(10) Pub. No.: US 2018/0013893 A1
(43) Pub. Date: Jan. 11, 2018

(54) COMPUTERIZED SIMULTANEOUS INTERPRETATION SYSTEM AND NETWORK FACILITATING REAL-TIME CALLS AND MEETINGS

(71) Applicant: SPEAKEZ LTD., Sde Warburg (IL)

(72) Inventor: Eyal COHEN, Sde Warburg (IL)

(73) Assignees: SPEAKEZ LTD., Sde Warburg (IL); SPEAKEZ LTD., Sde Warburg (IL)

(21) Appl. No.: 15/501,163

(22) PCT Filed: Aug. 3, 2015
(86) PCT No.: PCT/IL2015/050799

§ 371 Date: Feb. 1, 2017

Related U.S. Application Data
(60) Provisional application No. 62/033,220, filed on Aug. 5, 2014.

(51) Int. Cl. H04M 3/56; G06F 17/28; H04L 12/18

(52) U.S. Cl. CPC H04M 3/56; G06F 17/289; H04M 2203/2061; H04L 12/1881

(57) ABSTRACT

A computerized VoIP system which provides a computerized service for facilitating face-to-face and/or telephone meetings, in real time, between persons lacking a common language or having language barriers such as accents and dialects e.g. by utilizing or generating a networked worldwide community of Simultaneous Interpreters, using e.g. POTS (Plain Old Telephone Service), Smart Phone or any mobile phone. A platform may thereby be provided for professional simultaneous interpreters and business/private people, where interpreters from all over the world may translate any face-to-face meeting or telephone call between business people in any combination of languages, in real time.

### REFERENCE TO CO-PENDING APPLICATIONS

Priority is claimed from U.S. provisional application No. 62/033,220 entitled “Computerized simultaneous interpretation system and network facilitating real-time calls and meetings . . . ”, and filed Aug. 5, 2014.

### FIELD OF THIS DISCLOSURE

The present invention relates generally to teleconferencing.

### BACKGROUND FOR THIS DISCLOSURE

The need for translation services in a wide variety of applications is apparent e.g. from:
www.reuters.com/article/2014/01/05/onehourtranslation-fortissimo-idUSL6N0KF01220140105
www.globes.co.il/news/article.aspx?did=1000902717
   www.buysigmo.com
http://www.globes.co.il/news/article.aspx?did=1000916539#fromelement=hp_more articles
http://.www.themarker.com/career/1.2240413

The disclosures of all publications and patent documents mentioned in the specification, and of the publications and patent documents cited therein directly or indirectly, are hereby incorporated by reference. Materiality of such publications and patent documents to patentability is not conceded.

### SUMMARY OF CERTAIN EMBODIMENTS

Certain embodiments of the present invention seek to provide a system for simultaneous translating of teleconference content by an interpreter who signs up for the teleconference responsive to a call for interpreter service in the conference. Certain communicants may hear less than all of the other teleconference communicants e.g. interpreter may only hear the participant s/he is translating. Certain communicants may hear other teleconference communicants at reduced volume e.g. each participant may hear the translation provided for her or him, overlaid over a reduced-volume audio presentation of the content that is being translated.

Certain embodiments of the present invention seek to provide a computerized simultaneous interpretation system and network facilitating real-time calls and face-to-face meetings between participants with no common language or other language barriers.

Meetings, face-to-face or via telephone, entail language and accent barriers. The difficulty is apparent mostly when there is no common language between the meeting participants. By default, the parties switch to English in order to ease communication. This situation is particularly common when doing business in the Far East. The common solution is to use a non-professional translator who works in the local company and allegedly speaks better English.

Language barriers cause frustration:
Participants' incomprehensible accent make the rolling out of the meeting (or call) flat in its content.
A detailed discussion (i.e., contract clauses) is complex and often impossible.
The translator becomes a mediator between the participants and the end result is that not all of the conversation details are translated.
A business phone call can be simply intolerable when impaired by a heavy accent, or when the speaker's command of the English language is limited.

According to certain embodiments the present invention seeks to provide a computerized simultaneous interpretation system and network facilitating real-time calls and meetings between participants lacking a common language or any other language barriers such as accents or dialects.

According to certain embodiments the present invention seeks to provide a system having some or all of the following characteristics: A computerized system, typically VOIP-based or PSTN (Public Switched Telephone Network), which includes a server operative to provide a service for facilitating face-to-face meetings and/or telephone calls, typically in real time, between persons lacking a common language, e.g. by utilizing or generating a virtual community of translators e.g. Simultaneous Interpreters.

According to certain embodiments the present invention seeks to provide a customizable bridge facilitating some or all of the above.

The present invention may include but is not limited to a system, also termed herein “speakEZ”, constructed and operative to allow persons who lack a common language or any language barriers, to communicate in real time and understand each other. The system may for example be operative to generate a 4-way (say) bridge between Participants a and b who lack a common language, a-to-b translator and b-to-a translator in which some or all of the following are provided.

Participant a hears b-to-a translator—optionally superimposed over b's sound track which is optionally presented at reduced volume—optionally does not hear a-to-b translator Participant b hears a-to-b translator—optionally superimposed over a's sound track which is optionally presented at reduced volume—optionally does not hear b-to-a translator
b-to-a translator hears b (optionally just b)
a-to-b translator hears just a (optionally just a)
Both translations are preferably simultaneous, not consecutive.
According to one optional embodiment, a simultaneous interpreter (e.g. the a-to-b translator) can elect to hear his colleague's (e.g. the b-to-a translator's) sound track e.g. by using the speakEZ application interface or by pressing a telephone key button or can hear b user if elects to do so.
The system may interconnect more than 2 users and more than 2 translators.

It is appreciated that the system of the present invention may be designed so that participants call into a custom VoIP bridge as described herein (or the bridge may call the participants). Any equipment that links telephone lines may be employed. For example, the 3rd Generation Partnership Project (3GPP) defines a technical specification (TS 24.147) for conferencing within the IP Multimedia Subsystem (IMS) based on the Session Initiation Protocol (SIP), SIP Events, the Session Description Protocol (SDP) and the Binary Floor Control Protocol (BFCP, aka RFC4582). The system may include a network for professional Simultaneous Interpreters and business/private people, where interpreters from all over the world translate over the phone and using speakEZ system or interface, any face-to-face meeting or telephone call between business/private people in any combination of languages, in real time.

The system may provide a platform where business people no longer need to worry about any language barriers and they can have a meeting or business phone conversation where they speak using their language of choice and listen, via earphone, to the other participants using professional simultaneous interpreters. The service may be characterized by one or more of the following:
The meeting participants and the simultaneous interpreters connect to the server via an application on the smartphone (calling from a landline is an option).
In face-to-face meetings the participants can have an effective interaction since they conduct a personal and direct conversation, pay attention to body language, voice intonation and facial impressions, all while hearing the accurate translation in their earphone.
In telephone conversations the participants hear the accurate translation in their earphone while hearing each other in reduced volume so they can still feel the voice intonation of the meeting participants.

The Simultaneous Interpreters' Network may be characterized by one or more of the following:
Simultaneous interpreter professionals from any location are a click away from joining the service. The system allows professionals to determine their availability schedule and the languages of their expertise so that the system may assign them to translate a meeting or a phone conversation that occurs anywhere on the globe.
The admission process of the translators and the rating of their service assures a high quality of translation.

The users' Community may be characterized by one or more of the following:
a service to increase the productivity of organizations that conduct international business where their management and sales teams have a high level of interaction with their counterparts that speak foreign languages.
Fees based on actual usage of the service e.g. on a per minute basis.
Allows the users to book the service with the language of need ahead of the meeting schedule.
On the meeting schedule, the system, either automatically or as initiated by the user, connects the meeting participants and translators and the simultaneous translation starts.
At the end of the translation session the participants can rate the service. Their rating may be taken into account in future bookings of the translators. The system may also comprise an automated system for ranking interpreter quality.

According to certain embodiments, the Cloud Server matches customer translation needs (language skills, requested translation time) with translators from the community and provides engagement, scheduling, reminders and setup of the translation service event. In addition the server handles the users' and translators' communities and other optional services such as: billing, rating and fund clearance.

The system may be characterized by one or more of the following:

Clients are the ones with translation needs
Translators are part of network
The system can facilitate conversation using any suitable technology e.g. via:
   POTS (Plain Old Telephone Service)
   regular cellular phone
   Via app—When using smartphone
   Direct dial—When using landline—using DTMF

An echo system may be built up around one or more of: call scheduler, billing & clearance, local dialup, sign up, rating, scalability.

The system may include a conference bridge which may have added capabilities. In operational mode every user can hear one or more participants, and/or every user can listen to different participants. Commands added to support the operational mode may include some or all of:
1. Configure custom mix: According to one embodiment, this command configures the custom mix mode between a source channel and a destination channel. When working in operational mode, audio which arrives from the source channel may be added to the destination channel audio mix. This command typically does not start or stop the operational mode; this may be done using the “Set custom mix mode” command.
a. Parameters may include some or all of:
   i. Conference ID—a unique identifier for the conference
   ii. Source channel ID—the source audio channel
   iii. Destination channel ID—the destination audio channel
   iv. Reduction factor—an integer, value −1 or less. If this parameter is less than −1 each audio sample from the source channel is divided by the absolute value of the reduction factor. This way a participant can hear a quieter version of another participant's voice.
   v. Mute by default—0 or 1. If it is 1 this configuration is muted by default, otherwise it is not muted.
2. Toggle mute:
This commands toggles between mute and unmuted mode for a source channel/destination channel pair.
a. Parameters may include some or all of:
   i. Conference ID—a unique identifier for the conference
   ii. Source channel ID—the source audio channel
   iii. Destination channel ID—the destination audio channel

The system may include a Cloud Server (“SECS”) being hosted on, say, Amazon Elastic Computed Cloud (EC2) or any other suitable hosted service. A custom bridge may be provided to match customer translation needs (language skills, requested translation time) with translators from the community and may provide engagement, scheduling, reminders and setup of the translation service event. In addition the server may handle the users' and translators' communities and other services such as: billing, rating and fund clearance.

Some or all of the following embodiments may be provided:

### Embodiment i

A computerized system generating a virtual community of Simultaneous Interpreters and business/private people, allowing interpreters from all over the world to translate a face-to-face meeting or telephone call between business people in any of a variety of languages, in real time.

### Embodiment ii

A system according to any of the preceding embodiments which harnesses social networks to the virtual community.

### Embodiment iii

A system according to any of the preceding embodiments wherein meeting participants and simultaneous interpreters connect to a server via an application on through their smartphone.

### Embodiment iv

A system according to any of the preceding embodiments wherein meeting participants and simultaneous interpreters connect to a server via an application on through their regular cell phone. (e.g. Using DTMF).

### Embodiment v

A system according to any of the preceding embodiments wherein meeting participants and/or simultaneous interpreters call in from a landline, e.g. direct dial using DTMF.

### Embodiment vi

A system according to any of the preceding embodiments wherein simultaneous interpreters can enter their availability schedule.

### Embodiment vii

A system according to any of the preceding embodiments wherein simultaneous interpreters can enter the languages of their expertise.

### Embodiment viii

A system according to any of the preceding embodiments wherein at the predetermined starting time of a booked meeting, the system automatically connects the meeting participants and translators and the simultaneous translation starts or the system dials to the participants.

### Embodiment ix

A system according to any of the preceding embodiments wherein at the end of the translation session the participants can rate the service and their rating may be taken into account in future bookings of the translators, thereby ensuring that rating of simultaneous interpreters' service by the users' community assures a high quality of translation.

### Embodiment x

A system according to any of the preceding embodiments wherein the system includes a (cloud) server operative for matching customer translation needs (language skills, requested translation time) with translators from the community.

### Embodiment xi

A system according to embodiment x which also
a. Provides engagement, scheduling, reminders and setup of the translation service event; and/or
b. Handles the users' and translators' communities.

### Embodiment xii

A system according to any of the preceding embodiments wherein the system is operative in one or both of: Same-room mode (e.g. face to face meeting) and not-same-room mode.

### Embodiment xiii

A system according to any of the preceding embodiments wherein an at least 4-way (say) conference call is generated between at least participants a, b speaking languages a, b, and a-to-b translator and b-to-a translator in which some or all of the following apply:
a. Participant hears b-to-a translator—optionally superimposed over b's sound track which is optionally presented at reduced volume—optionally does not hear a-to-b translator.
b. Participant b hears a-to-b translator—optionally superimposed over a's sound track which is optionally presented at reduced volume—optionally does not hear b-to-a translator.
c. b-to-a translator hears b (optionally just b).
d. a-to-b translator hears just a (optionally just a).
e. One or both translators are preferably simultaneous not consecutive.

Where participants a & b may be part of the users community; a-to-b translator and b-to-a translator are part of the interpreters' marketplace.

### Embodiment xiv

A system according to any of the preceding embodiments wherein at least one of the following commands are employed, e.g. to support the operational mode: Configure custom mix; Toggle mute; Volume; Ability to control which of any of the users or the translators that are heard.

### Embodiment xv

A system according to embodiment xiv wherein the “Configure custom mix” command includes at least one of the following parameters:
a. Conference ID—a unique identifier for the conference
b. Source channel ID—the source audio channel
c. Destination channel ID—the destination audio channel
d. Reduction factor—an integer, value −1 or less. If this parameter is less than −1 each audio sample from the source channel is divided by the absolute value of the reduction factor. This way a participant can hear a quieter version of another participant's voice.
e. Mute by default—0 or 1. If it is 1 this configuration is muted by default, otherwise it is not muted.

### Embodiment xvi

A system according to embodiment xiv-xvi wherein the “Toggle mute” command includes at least one of the following parameters:
a. Conference ID—a unique identifier for the conference
b. Source channel ID—the source audio channel
c. Destination channel ID—the destination audio channel

### Embodiment xviii

A system according to any of the preceding embodiments wherein the system comprises a VoIP-based system.

### Embodiment xix

A system according to any of the preceding embodiments wherein the system may allow the users to book the service with the language of need ahead of the meeting schedule.

There are also thus provided, at least the following embodiments:

### Embodiment 1

A conferencing system which provides a service to conference participants, the system comprising:

a teleconference bridge server operative for controlling a telephony provider to facilitate teleconferences between previously defined communicants; and

an application server including:
a conference definition environment operative to allow conference initiators to define at least one requested conference's time, participants and need, if any, for at least one conference service provider to provide at least one conference service to at least one of the participants at said time; and
a communication interface including:
   electronic notification functionality operative to send electronic notification to at least a portion of a population of service providers of at least one desired conference's time and need for at least one conference service provider, as defined via the environment; and
   at least one processor operative to receive at least one message from at least one individual service provider in the population of service providers, each message confirming intention of the individual service provider to provide the service for the individual conference, and to command the telephony provider, via the teleconference bridge server, to add the individual service provider to the individual conference by establishing at least one audio channel between the individual service provider and at least one of the participants.

### Embodiment 2

A system according to any of the preceding embodiments wherein the conference comprises a teleconference.

### Embodiment 3

A system according to any of the preceding embodiments wherein the conference comprises a face to face meeting and wherein there is no option for communicants to hear other communicants via telephone since communicants hear one another directly.

### Embodiment 4

A system according to any of the preceding embodiments wherein the service comprises translation from a language which one participant is registered to have knowledge of, to a language which another participant is registered to have knowledge of.

### Embodiment 5

A system according to any of the preceding embodiments wherein the electronic notification functionality comprises push notification functionality.

### Embodiment 6

A system according to any of the preceding embodiments wherein the processor is configured to command the teleconference bridge server, as a default, to mute at least one channel to at least one interpreter translating a specific teleconference participant, other than a channel from the specific teleconference participant to the interpreter, which is not muted.

### Embodiment 7

A system according to any of the preceding embodiments wherein the processor is configured to command the teleconference bridge server, as a default, to reduce volume for at least one channel from a first teleconference participant to a second, if the first is being translated for the second.

### Embodiment 8

A system according to any of the preceding embodiments wherein the processor is configured to command the teleconference bridge server, as a default, to mute at least one channel from at least one interpreter to at least one specific teleconference participant, if the interpreter is translating from a language the specific teleconference participant understands.

### Embodiment 9

A system according to any of the preceding embodiments wherein the system has teleconference initiator-selectable modes including a normal teleconference reservation mode for defining teleconferences to be held at a future time, and an immediate call mode for defining teleconferences to be held immediately, and wherein, when the system is in normal mode, the application server is configured such that any requested teleconference is accepted unless there is an unusual circumstance requiring the requested teleconference to be denied; whereas when the system is in immediate call mode, the application server is configured such that any requested teleconference is accepted only if at least one individual service provider from the population of service providers responds to the electronic notification within a time-out period.

In this mode the service provider typically is not required to respond since s/he is already online and awaiting a translation call. Instead, s/he may be dispatched automatically by the system to service an incoming request for a conference call within the time-window of the service provider's availability.

### Embodiment 10

A system according to any of the preceding embodiments wherein the communication interface is configured to receive from at least one individual service provider in the population of service providers, an availability indication indicating that the service provider is currently available and wherein the system has teleconference initiator-selectable modes including an immediate call mode for defining teleconferences to be held immediately, and wherein, when the system is in immediate call mode, the application server is configured to send the electronic notification only to those specific service providers within the population of service providers which have previously provided an availability indication which is still in force.

### Embodiment 11

A system according to any of the preceding embodiments wherein the electronic notification functionality is operative to send electronic notification only to service providers capable of fulfilling the need, thereby to ensure that each service provider added to the individual teleconference is capable of fulfilling at least one need of at least one participant thereof.

### Embodiment 12

A system according to any of the preceding embodiments wherein the service providers comprise interpreters and wherein the application server is configured to receive, from at least one of the initiators defining at least one requested teleconference's time, participants and need, language proficiency data for participants of the teleconference and wherein the electronic notification functionality is operative to send electronic notification only to interpreters capable of translating between languages which, according to the language proficiency data, are known by some of the participants, and not by others.

### Embodiment 13

A system according to any of the preceding embodiments wherein the application server is configured to receive, from at least one of the initiators defining at least one requested teleconference's time, participants and need, an indication of how many service providers s/he wishes to engage for the requested teleconference.

### Embodiment 14

A system according to any of the preceding embodiments wherein the service providers comprise interpreters and wherein at least one interpreter between first and second languages known by some participants and not others is required for the requested teleconference and wherein the application server is configured to receive, from at least one of the initiators defining at least one requested teleconference's time, participants and need, an indication of whether s/he wishes to engage for the requested teleconference:

only a single interpreter proficient in the first and second languages to interpret from the first language to the second, and vice versa, during the requested teleconference, or

a pair of interpreters each proficient in the first and second languages, the pair including a first interpreter to interpret from the first language to the second language during the requested teleconference and a second interpreter to interpret from the second language to the first during the requested teleconference.

### Embodiment 15

A system according to any of the preceding embodiments wherein the service providers comprise interpreters and also comprising a database storing contact particulars and language proficiencies of registered service providers.

### Embodiment 16

A system according to any of the preceding embodiments and also comprising accumulated quality indicators for at least some of the service providers, quantifying quality of service provided to date by the interpreters.

### Embodiment 17

A system according to any of the preceding embodiments and wherein the application server defines, for at least one pair of first and second communicants associated with at least one teleconference, whether or not the first communicant hears the second communicant.

### Embodiment 18

A system according to any of the preceding embodiments and wherein the application server defines, for at least one pair of first and second communicants associated with at least one teleconference, the volume at which the first communicant hears the second communicant.

### Embodiment 19

A system according to any of the preceding embodiments wherein the application server selects, from the database, appropriate registered service providers whose language proficiencies correspond to at least one conference's need for service and wherein the electronic notification functionality is operative to send the electronic notification to the appropriate registered service providers.

### Embodiment 20

A conferencing method which provides a service to conference participants, the method comprising: Employing a teleconference bridge server for controlling a telephony provider to facilitate teleconferences between previously defined communicants; and

Providing an application server including:
a conference definition environment operative to allow conference initiators to define at least one requested conference's time, participants and need, if any, for at least one conference service provider to provide at least one conference service to at least one of the participants at the time; and
a communication interface including:
   electronic notification functionality operative to send electronic notification to at least a portion of a population of service providers of at least one desired conference's time and need for at least one conference service provider, as defined via the environment; and
   at least one processor operative to receive at least one message from at least one individual service provider in the population of service providers, each message confirming intention of the individual service provider to provide the service for the individual conference, and to command the telephony provider, via the teleconference bridge server, to add the individual service provider to the individual conference by establishing at least one audio channel between the individual service provider and at least one of the participants.

### Embodiment 21

A computer program product, comprising a non-transitory tangible computer readable medium having computer readable program code embodied therein, the computer readable program code adapted to be executed to implement a conferencing method which provides a service to conference participants, the method comprising:

Employing a teleconference bridge server for controlling a telephony provider to facilitate teleconferences between previously defined communicants; and

Providing an application server including:
a conference definition environment operative to allow conference initiators to define at least one requested conference's time, participants and need, if any, for at least one conference service provider to provide at least one conference service to at least one of the participants at the time; and
a communication interface including:
   electronic notification functionality operative to send electronic notification to at least a portion of a population of service providers of at least one desired conference's time and need for at least one conference service provider, as defined via the environment; and
   at least one processor operative to receive at least one message from at least one individual service provider in the population of service providers, each message confirming intention of the individual service provider to provide the service for the individual conference, and to command the telephony provider, via the teleconference bridge server, to add the individual service provider to the individual conference by establishing at least one audio channel between the individual service provider and at least one of the participants.

Also provided is a conferencing system which provides a service to conference participants, the system comprising:

a teleconference bridge server operative for controlling a telephony provider to facilitate teleconferences between previously defined communicants; and

an application server including:
a conference definition environment operative to allow conference initiators to define at least one requested conference's time, participants and need, if any, for at least one conference service provider to provide at least one conference service to at least one of the participants at the time; and
a communication interface including:
   at least one processor operative to receive at least one message indicating intention of an individual service provider to provide the service for the individual conference, and to command the telephony provider, via the teleconference bridge server, and to add the individual service provider to the individual conference by establishing at least one audio channel between the individual service provider and at least one of the participants,

wherein the processor is configured to command the teleconference bridge server, as a default, to perform at least one of the following:

muting at least one channel to at least one interpreter translating a specific teleconference participant, other than a channel from the specific teleconference participant to the interpreter, which is not muted; and/or

reducing volume for at least one channel from a first teleconference participant to a second, if the first is being translated for the second.

According to certain embodiments, each communicant (participant/user or service provider/interpreter/translator) is defined as an object; and/or each request to schedule or reserve a call is defined as an object, and/or each call is defined as an object, which may be derived from the corresponding call request object.

A face to face meeting is a possible use case for certain embodiments; in a face to face meeting a user may schedule a call similarly to scheduling a normal teleconference call. The only difference between a phone call and a face to face meeting may be that in face to face, there is no option for users to hear another user on the phone since the users already hear the user directly.

Also provided, excluding signals, is a computer program comprising computer program code means for performing any of the methods shown and described herein when said program is run on at least one computer; and a computer program product, comprising a typically non-transitory computer-usable or -readable medium e.g. non-transitory computer-usable or -readable storage medium, typically tangible, having a computer readable program code embodied therein, said computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with some or all of the embodiments of the present invention. Any or all functionalities of the invention shown and described herein, such as but not limited to operations within flowcharts, may be performed by any one or more of: at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, BluRays, magnetic-optical discs or other discs; RAMs. ROMs, EPROMs, EEPROMs, magnetic or optical or other cards, for storing, and keyboard or mouse for accepting. Modules shown and described herein may include any one or combination or plurality of: a server, a data processor, a memory/computer storage, a communication interface, a computer program stored in memory/computer storage.

The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”. “estimating”, “selecting”, “ranking”, “grading”, “calculating”, “determining”. “generating”. “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein.

Functionalities shown and described herein may be divided between server/s computer/s and a plurality of client computers. These or any other computerized components shown and described herein may communicate between themselves via a suitable computer network.

### BRIEF DESCRIPTION OF THE DRAWINGS

Certain embodiments of the present invention are illustrated in the following drawings:

FIGS. 1-3 are simplified block diagram illustrations constructed and operative in accordance with embodiments of the present invention. Modules based on available code or formats or protocols may alternatively be implemented using code or formats or protocols which are not identical to those specifically illustrated but have relevant features in common.

FIGS. 4a-4c, taken together, form a simplified flowchart illustration of a method operative, e.g. in conjunction with any or all of FIGS. 1-3, in accordance with an embodiment of the present invention. The method of FIGS. 4a-4c typically comprises some or all of the illustrated operations, suitably ordered e.g. as shown.

Methods and systems included in the scope of the present invention may include some (e.g. any suitable subset) or all of the functional blocks shown in the specifically illustrated implementations by way of example, in any suitable order e.g. as shown.

Computational components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Any method described herein is intended to include within the scope of the embodiments of the present invention also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF CERTAIN EMBODIMENTS

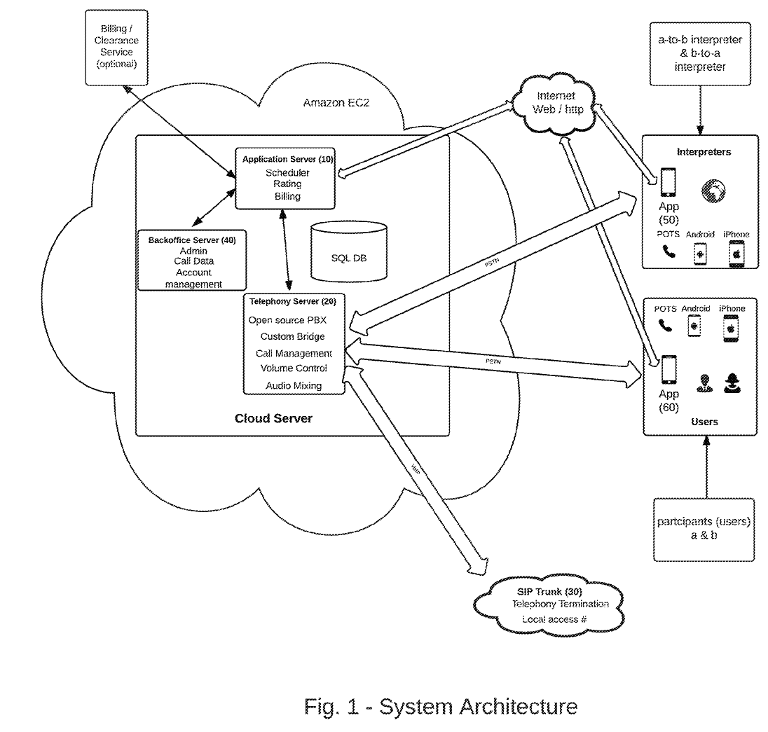

Teleconferencing systems and methods are now described with reference to FIGS. 1-4 herein. The systems and methods typically enable a service such as translation to be provided to conference participants in real time, by service providers such as interpreters who have previously signed up to do so. The system may comprise a teleconference bridge server, or telephony server, operative for controlling a telephony provider to facilitate teleconferences between previously defined communicants. An application server may be provided which may be operative to receive, from human conference initiators, definitions of requested conferences' time, participants and need, if any, for service providers. The service providers e.g. interpreters provide at least one conference service e.g. translation to at least one participant during the conference. Electronic notification functionality may send electronic notification of at least one desired conference's defined time and need for conference service providers, to the entire population of service providers, or to a portion thereof (for example, if only some are known to be available at a specific time, or if only some are known to have the relevant language skills). At least one processor may be operative as a scheduler, to receive message/s from individual service provider/s, each message confirming intention or ability of the service provider to provide service for an individual conference. If many service providers respond, only one may be selected e.g. on a first come first serve basis or by seniority or any other logic. The processor may then command the telephony provider, via the teleconference bridge server, to add the relevant service provider to the conference by establishing at least one audio channel between the service provider and at least one participant, depending on decision logic described herein. Alternatively, only the application server or only the telephony server may be provided, rather than both.

FIG. 1 is a simplified block diagram illustration of a system according to an embodiment of the invention. Some or all of the illustrated modules may be provided.

The Application server 10 manages the application's logic on the server side including all or any subset of the following functionalities e.g. as described in more detail below.

a. reading and writing data from the database

b. setting and tearing down calls on the telephony server 20

c. managing call states and flows

d. handling interactions with the user and interpreter applications 50, 60, e.g. over http

e. sending electronic e.g. push notifications to service providers e.g. interpreters, e.g. via Apple APN or Google GCM

The application server is typically scalable and may run on an elastic cloud platform such as Amazon's EC2. Multiple instances of the application server can be set up or tom down according to the current system load and may have http communication. Data from the client side's javascript may be serialized and deserialized to JSON. jax-rs may be employed to automatically convert the data to java POJOs such that no data conversion code need be written in the server.

The telephony server 20 typically has Audio Mixing functionality: for each participant or communicant, the input to its conferencing bridge is the digital audio generated by each participant and the output returned to each participant is the audio signals generated by all other participants, suitably mixing for a given time slot.

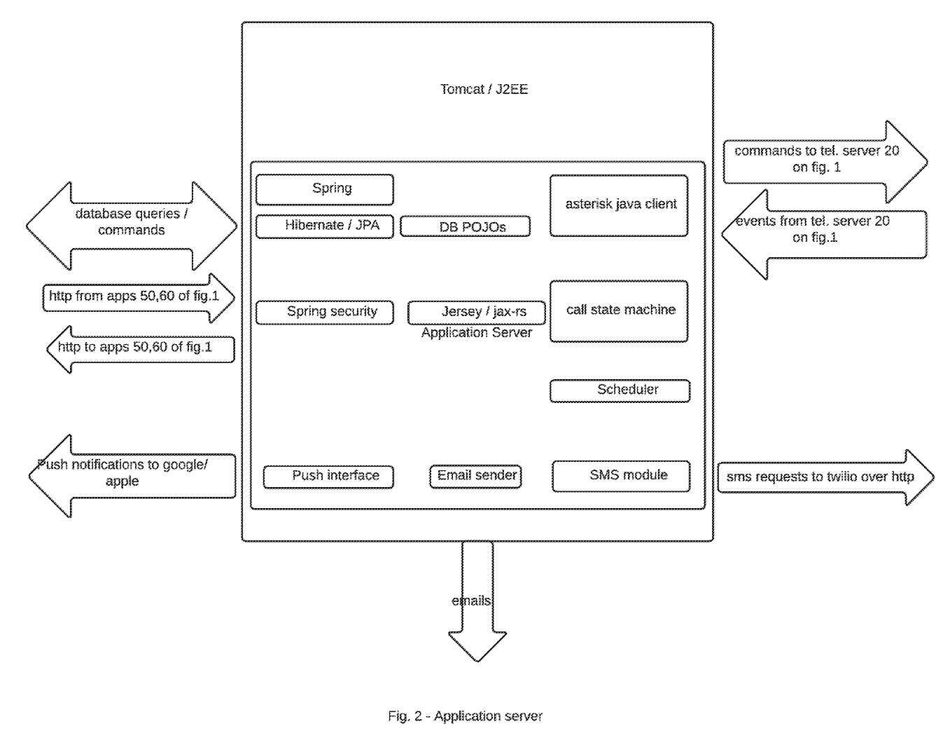

According to certain embodiments, as described herein, the bridge (FIG. 2) mixes the audio signals with different weights (1 for some participants, 1/12 or 1/18 or 1/3 for others, depending on the volume level as described herein). Volume changes are typically sent from the app server to the telephony server. According to certain embodiments, volume change controls a division factor inside the telephony server's configurable teleconference bridge (FIG. 2), e.g. a high factor means high denominator so the volume is low, low factor means low denominator so the volume is high.

The telephony server 20 also typically has call management functionality which typically is determined by the app server's call state machine, e.g. as described by the flow of FIGS. 4a-4c herein. For example, the state machine may define that if a call is connected and someone presses the hangup button, all other users are to be disconnected by the app server.

The telephony server 20 may for example run on a conventional Asterisk telephony server in a high priority setup to minimize audio jitter for call smoothness and may be almost infinitely scalable, similar to the application server. The telephony server's bridge may for example be based on a modified version of Asterisk's confbridge application Telephony provider 30, e.g. a SIP trunk, typically comprises a cloud based VoIP proxy which may serve as the system's single point of entry for routing signaling and audio data to PSTN. According to certain embodiments, the SIP trunk 30 converts this data to signals useable by conventional PSTN telephone equipment. According to certain embodiments, behind the proxy there is a network of gateways mapped in various different ways e.g. geographical location. The proxy passes the call through the gateway deemed most adequate.

The SIP trunk may provide some or all of the following functionalities:

a. handles telephony termination

b. handles conversion between PSTN protocols (e.g. ISDN, SS7) to IP telephony protocols (e.g. SIP, RTP)

c. provides inbound access number which may be redirected to the system's IP telephony server/s.

User application 60 allows a conference initiator to generate requests for one or more service providers to provide a service for a given teleconference at a given time including designation of language requirements e.g. for interpretation service. During a conference, application 50 (and/or 60) may allow the user/interpreter to affect the relative volume at which various other communicants are heard or whether they are heard at all; suitable default options may be defined and user interface simplicity may be maintained by allowing only specific pre-programmed prevalent adjustments of volume and muting to be effected via the app e.g. as described herein. User application 60 typically provides interaction between end users and the system. User application 60 typically handles flow such as but not limited to any or all of: registration, call scheduling, making calls from the smartphone, changing volume, mute/unmute.

Interpreter application 50 allows an interpreter to accept requests for one or more service providers to provide a service for a given teleconference at a given time including designation of language abilities e.g. for interpretation service. Interpreter application 50 typically handles interactions between the interpreters and the system. Interpreter application 50 typically handles flows such as interpreters' requests for call assignments, interpreter availability handling, user mute/unmute, volume changes.

According to certain embodiments, communicants register with the application server 10 e.g. via interpreter app 50 and participant app 60 and their particulars are suitably stored e.g. in the database of FIG. 1. A suitable user registration flow may include some or all of the following elements:
user downloads the app 60
user enters his cell phone number
application server sends an SMS to the user with a verification code. The user enters the verification code to see that his cell phone is correct.
user fills in personal details such as name, email address and password, and fills in which languages he speaks
   A suitable interpreter registration flow may include some or all of the following elements:
The interpreter downloads the interpreter app 50
An sms verification process is run e.g. as described above with reference to the user's app 60
interpreter fills in personal details such as name, email address and password, fills in which languages he speaks, and which are native, and fills in which language directions has experience interpreting (e.g. English to Hebrew as opposed to Hebrew-English with which he may have less experience).

For example, the user and interpreter apps may be written in cordova to leverage a “write once, run anywhere” paradigm. Backbone.js may be used to leverage an mvc (model, view, collection) approach and to simplify data communication with the application server 10. Handlebars may be used for fast html templating. Require.js may be used to minimize the load on the smartphone's RAM and CPU. Only data which is currently relevant may be loaded to each app's webview. Fastclick may be used to speed up webview responsiveness.

The Database of FIG. 1 may employ a standard relational db structure (e.g. mysql). indexing may be used on frequently accessed data for performance.

It is appreciated that PSTN and VoIP may both be provided, or only PSTN may be employed, or only VoIP.

TCP/IP between the app server and the telephony server may be replaced by any suitable telephony server commands/telephony server events using any suitable protocol.

Amazon EC2 may be replaced or augmented by any suitable elastic cloud computing provider.

The application, back-office and telephony servers may be united into a single server or their functionalities may be provided as 2 or 3 or n separate servers. All or any subset of the illustrated functionalities may be provided. In the illustrated embodiment, 3 servers are provided, in the description, the functionalities of the application and back-office servers may be assumed to be provided by a single server.

Some functionalities of the servers may be provided by or in conjunction with legacy equipment or within legacy environments. For example, the telephony server may be based on any suitable software (or other) implementation of a telephone exchange e.g. private branch exchange—PBX) such as but not limited to Asterisk which may allow attached telephones to make calls to one another, and to connect to other telephone services, such as the public switched telephone network (PSTN) and Voice over Internet Protocol (VoIP) services. The system may employ or build upon features of the legacy PBX such as conference calling, interactive voice response (phone menus), and automatic call distribution. Existing functionality in legacy environments may be built upon to generate the functionality described herein in any suitable manner e.g. by writing dial plan scripts in Asterisk's own extensions languages, by adding custom loadable modules written in C, by implementing Asterisk Gateway Interface (AGI) programs using a programming language capable of communicating via the standard streams system (e.g. stdin and stdout), by network TCP sockets, and so forth.

Any suitable operating system may be employed to implement functionalities of the present invention; for example Asterisk runs on a variety of operating systems, including NetBSD, OpenBSD, FreecBSD, Mac OS X, Linux and Solaris.

Any suitable voice over IP protocol may be employed, such as but not limited to Session Initiation Protocol (SIP), Media Gateway Control Protocol (MGCP), and H.323.

Computer telephony integration technology, also called computer-telephone integration or CTI, may be employed to allow telephone interactions to be integrated or coordinated with server-based functionality such as but not limited to automatic call routing.

FIG. 2 is a simplified block diagram illustration of the application server 10 of FIG. 1. The application server 10 may for example be written in java as a j2ee server and runs under standard j2ee, e.g. using tomcat 7.0. A Web service may use standard jax-rs interface, e.g. with the jersey implementation. Spring may be used for component dependency injection. The JPA specification (hibernate implementation) may be used for converting database data to POJOs; no data conversion code need to be implemented. Obviously, this is but one possible implementation.

The application server may be multithreaded with minimal locks for maximizing performance. Locks may be performed on call objects so resource contention can only exist between multiple events on the same call and not between different calls. Java's concurrent data structure infrastructure may be used to avoid redundant locking.

Conventional log 4j logging systems may be used so the system can report log events to files, monitoring systems, system administrators. Twilio's HTTP API may be used for SMS termination where Twilio is an example implementation of SMS gateway functionality. Spring security framework may be used for validating requests from users and administrators; requests to sensitive resources may be discarded if the requests which lack valid authorization headers. Encrypted https traffic may be used between the application server 10, user applications 60 and interpreter applications 50. Obviously, this is but one possible implementation.

Spring's asynchronous thread pooling framework may be used for handling long requests. For example, when a user asks for a scheduled call the application server may send push notifications inviting the interpreters for the call. This may be done asynchronously, after the response was sent to the user so the user does not have to wait.

The app server may use the STATE pattern for call state machine handling, to ensure that only one singleton object is created for each state, increasing the system's efficiency. Call specific data may be saved on a different call object.

Typically, the app server is almost infinitely scalable. Every app server can handle a given amount of calls and users and if more are added another app server can be set up immediately by the elastic infrastructure.

Possible interactions between the modules of FIG. 2, some or all of which may be provided, are now described.

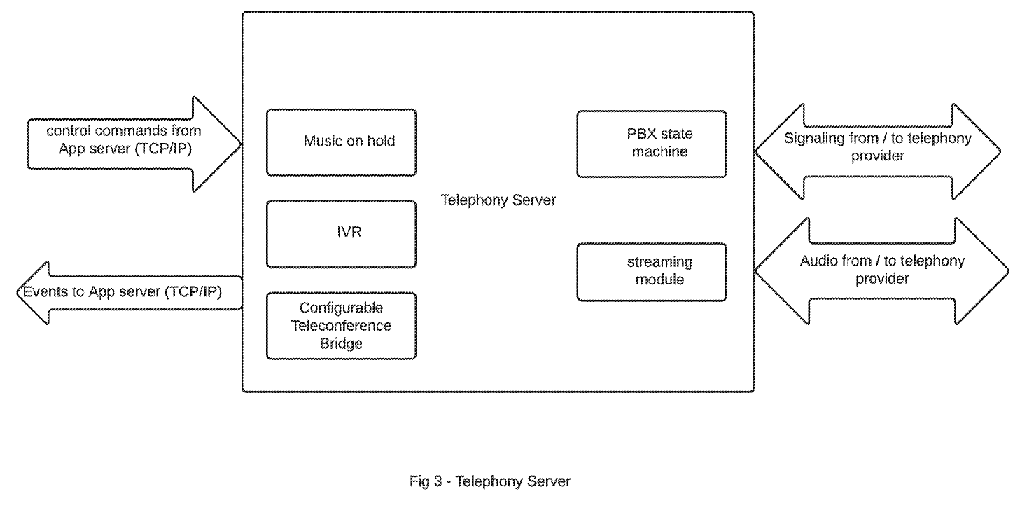

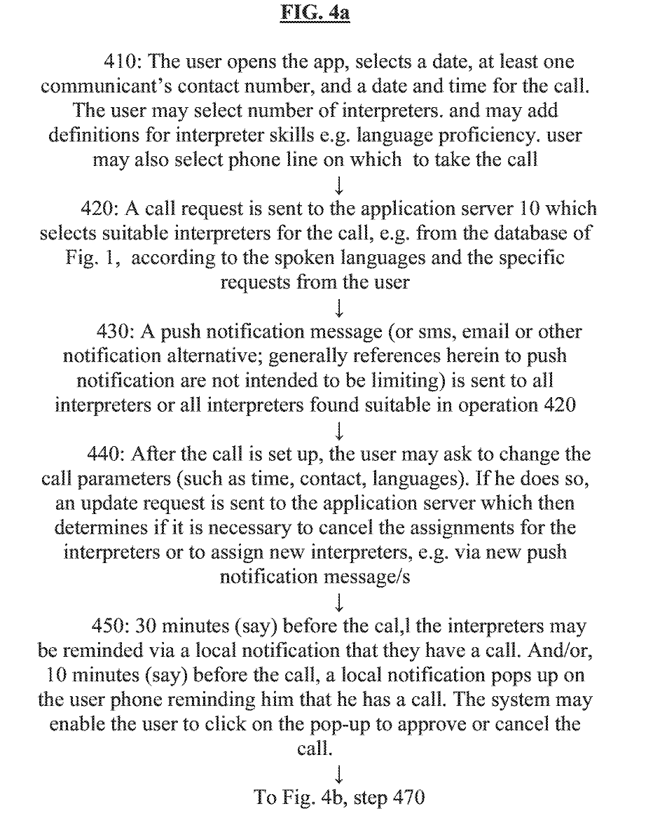

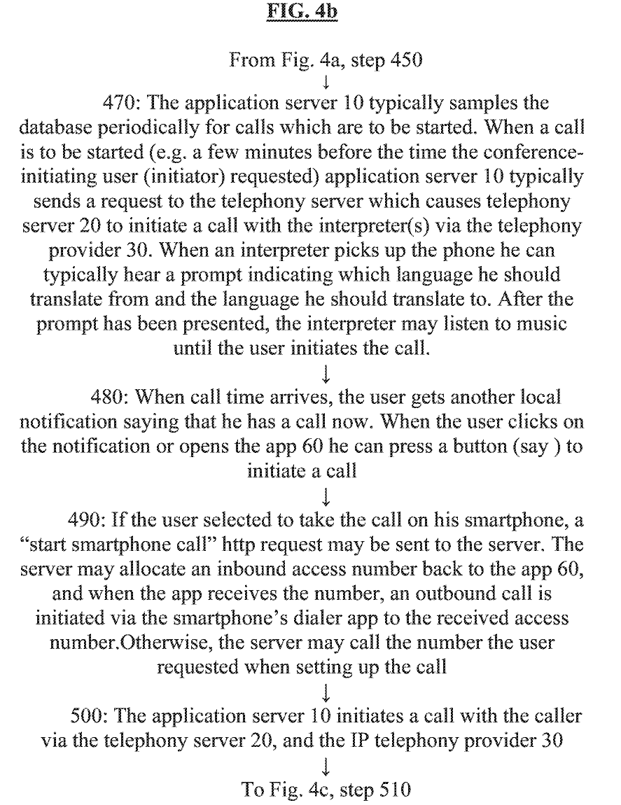

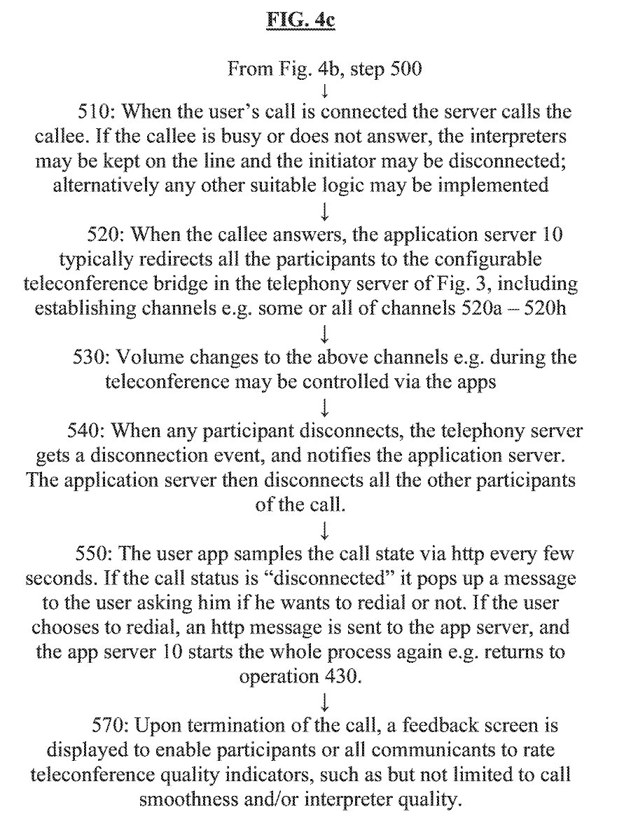

The scheduler of FIG. 2 samples the database of FIG. 1 upon occasion e.g. periodically such as every minute, to see which calls should be started and to whom, since the database of FIG. 1 stores particulars of registered participants and/or service providers as well as an indication of each teleconference which has been reserved or scheduled by initiator/s. When a teleconference call is started, the application server's scheduler may send an “originate call” (aka “start call”) message to the telephony server 20 of FIG. 3 which may responsively send a call request to the telephony provider 30 of FIG. 1. Responsively, the telephony provider 30 may send a suitable message to the interpreter's telephone company backend (cellular, landline, etc). For example, the telephony provider 30 of FIG. 1 may initiate a call request on its PSTN interface to the interpreter's cellular provider, which may responsively call the interpreter's phone and establish suitable channel/s between the interpreter and one or more teleconference participants, such as one channel from a first participant to be interpreted (language A to B) to the interpreter, and another channel from the interpreter to a second participant who knows language B but not A. Two voice channels, for Tx and Rx respectively (e.g. PSTN channels) may be established between the telephony provider 30 and the interpreter's phone, and two, again for TX. RX respectively between the telephony server of FIG. 3 and the telephony provider of FIG. 1 (e.g. VoIP channels).

Any suitable setup process may be employed. For example, if VoIP technology is used all the way, the following setup process may be used, for whichsoever TX and/or RX channels are to be established between teleconference communicants, which may depend on teleconference-specific logic as described herein:

2a. app server 10 sends a start call message to the telephony server 20.
2b. telephony server 20 sends a VoIP start call request to the interpreter's phone data interface over the Internet (this may pass several routers on the way including some data routers at the interpreter's cellular provider).
2c. when the interpreter answers the call two VoIP channels are established between the telephony server 20 and the interpreter's phone (TX, RX).

Alternatively, if PSTN technology is used all the way, the following setup process may be used:

3a. app server 10 sends a start call message to the telephony server 20.
3b. The telephony server 20 includes suitable hardware PSTN interface component/s.
When telephony server 20 receives the start call request telephony server 20 opens a telephone line on its hardware interface and calls the interpreter who has signed up for this teleconference.
3c. the call is forwarded to the interpreter's phone company over PSTN.
3d. the phone company routes the call to the interpreter's phone.
3e. two PSTN channels are opened between telephony server 20 and the interpreter's phone company (TX, RX). Two channels are opened between the phone company and the phone (TX, RX) (e.g. over landline or cell).

Alternatively, in hybrid PSTN/VoIP implementations, the following setup process may be used:

1a. app server 10 sends a start call message to the telephony server 20.
1b. telephony provider 30 locates a suitable VoIP/PSTN gateway and forwards the request thereto.
1c. the VoIP/PSTN gateway calls the interpreter's telephone company via its PSTN interface.
1d. the telephone company calls the interpreter's phone
1e. two VoIP channels (TX, RX) are established between telephony server 20 and the gateway, two PSTN channels (TX. RX) are established between the gateway and the telephony company, and two channels (TX, RX) are established between the telephone company and the interpreter's phone (e.g. cellular or landline).

Still referring to FIG. 2, it is appreciated that Spring is an example of an dependency injection environment whose input comprises an xml text configuration file specifying configuration options for modules. The Spring output is operative for linking the actual objects in the code by putting references to objects inside other objects.

JPA is a specification for representing database data using java objects. Hibernate is an implementation thereof. The app server's logic pulls data from the db of FIG. 1 into the objects, manipulates the objects and writes objects back to the database. DB POJOs (Plain Old Java Object) are the objects Hibernate uses to enable the app server's logic to save or retrieve data from the database of FIG. 1.

Asterisk Java client is a module for sending commands to Asterisk using Java which may be used by the app server to sends commands to Asterisk and receive events therefrom.

jax-rs/jersey is an implementation of a specification for writing Java REST services where REST is a specification for writing web based services over http. jax-rs/jersey is operative to convert http commands sent from the user and interpreter apps 50, 60 to Java objects used by the app server 10, and vice versa.

The call state machine manages call states, including receiving as inputs, requests from users and interpreters and/or events from the telephony server 20. The call state machine's outputs include call statuses for the users and interpreters (e.g. via jax-rs/jersey), and commands to the telephony server 20 (e.g. via Asterisk Java).

The push interface sends push notifications to smartphone apps, receiving inputs comprising push requests from the app server's logic, and generating outputs comprising push notification messages to the apps.

The Email sender receives email requests from the application server's logic and generates emails to be sent to users.

The SMS module receives sms requests from the application server's logic, and generates SMS's to be sent to users.

Obviously, all aspects of the above implementation are only possibilities. All or any subset of the blocks illustrated and described above, may be provided, or known alternatives thereto, or none.

More generally, the application server 10 commands the telephony server, which in turn controls the physical aspects of the teleconference, based on events received from the telephony server 10 and/or based on the application server's interactions with 2 types of teleconference communicants:

i. the actual participants which seek to converse, and

ii. teleconference service providers such as translators/interpreters which provide service e.g. translation to the participants during the teleconference.

Commands from app server 10 to telephony server 20 may include some or all of: dial a number, hang up a channel, move a channel to the bridge, mute channel, adjust volume of channel.

Events recorded by the telephony server 20 and reported to the app server may include some or all of: channel disconnected, prompt occurred on channel, incoming call.

Typically, each potential participant communicates with the application server 10 via her or his participant app 60. Each potential service provider e.g. translator/interpreter.

Alternatively, websites e.g. mobile web sites or pagers may replace or augment apps 50, 60, as a mode of communication between server and participants and/or service providers.

A suitable connection e.g. http from apps 50, 60 to app server 10 allows the server 10 to receive requests from the apps such as but not limited to reserving a teleconference call, dialing, interpreter taking a call, call status request.

A suitable connection e.g. http from app server 10 to apps 50, 60 allows the server 10 to send responses and other messages, such as call status reply, meeting list for user or interpreter, request for available interpreters.

Electronic notifications e.g. push notifications may be sent, e.g. to Google/Apple, for example for notifying interpreters that a new (future or current) call has been set up, or notifying users that interpreters have been assigned to their call e.g. for a current (immediate) call.

It is appreciated that the particular implementation of FIG. 2 is not intended to be limiting. For example, push notifications may be replaced or augmented by other electronic notification technologies such as but not limited to email, http, sms, tcp/ip.

The Spring module may be replaced or augmented by any suitable dependency injection module.

The Hibernate/JPA module may be replaced or augmented by any suitable database abstraction layer.

The DB POJOs may be replaced or augmented by any suitable database objects.

The Asterisk Java interface may be replaced or augmented by any suitable telephony server communication module.

The Spring Security module may be replaced or augmented by any suitable http security layer.

The jersey/jax-rs module may be replaced or augmented by any suitable http/object conversion layer.

http for communication between application server 10 and apps 50, 60 in FIG. 1 is only one possible example of a protocol over TCP/IP; other such protocols may alternatively be employed.

Twilio may be replaced or augmented by any suitable cloud SMS provider.

FIG. 3 is a simplified block diagram illustration of the telephony server 20 of FIG. 1. All or any subset of the blocks illustrated may be provided, or alternatives to the blocks illustrated, as for FIGS. 1, 2.

Telephony server 20 typically comprises a server with IP telephony capabilities. All or any subset of the following functionalities are typically provided:

a. handles signaling interaction with the telephony provider using standard signaling protocols (such as SIP).
b. handles audio streaming to and from the telephony provider over a streaming protocol (such as RTP)
c. plays prompts and music on hold to participants
d. handles some of the application's telephony logic using scripts
e. sends telephony related events to the application server (such as call connected, call disconnected, prompt started, prompt done, etc).

The telephony server 20 typically includes a configurable teleconference bridge which may be based on a legacy component employed by the system of the present invention. The bridge of FIG. 3 may be similar to a conventional conferencing bridge however rather than every teleconference participant hearing all other participants, in the bridge of FIG. 3, logic is provided which determines who hears who for every pair of participants, and at which output level (volume). One possible setup is as follows: The initiator hears his translator at normal volume; initiator can choose to hear the callee (participant other than the teleconference initiator) at normal or at reduced volume, initiator does not hear interpreter to callee.

Typically, the configurable teleconference bridge is operative for some or all of the following functionalities:

a. handles audio flow in a call. Unlike in conventional conferencing calls, the communicants can only hear a configured subset of the other communicants e.g. as described herein. For example, participants can each only hear their interpreter and the callee, but not the other interpreter, whereas each interpreter can hear only the participant s/he is translating. Or, participants can each only hear their interpreter and callees who speak their language, but not other interpreters, whereas each interpreter can hear only participants but not other interpreters. Many other configurations are possible; it is appreciated that the subset of communicants that can be heard may be defined, by system logic, in terms of system-stored data regarding communicants e.g. the type of communicant (participant, interpreter) and/or relevant characteristics of each communicant e.g. the languages they are conversant in.

b. provides an interface to the application server for setting up and tearing down channels inside the bridge, e.g. by locking the entire bridge (no audio mixing occurs while the bridge is locked, so voice can be cut). It is appreciated that if a communicant were to press mute/unmute repeatedly and a channel is set up or torn down each time he presses, teleconference communicants may each stop hearing for a split second each time.

The interface may be provided using a protocol compatible with the telephony server e.g. Asterisk AMI if the telephony server is an Asterisk server. For example, the interface (for an Asterisk implementation) may include the following commands added as an extension to the conventional Asterisk AMI commands:

A configure_custom_mix(initiator_channel_ID,

initiator_interpreter_channel_ID, −12, TRUE, TRUE) command may cause the configurable teleconference bridge to route incoming audio from the initiator participant (who initiated the teleconference) to the initiator's interpreter, while reducing the audio amplitude by a factor of 12 (or any other parameter such as 3 or 18). The channel may be muted by default (first “true” parameter) and the initiator's interpreter may (second “true” parameter) be able to modify the channel's volume via the app.

A configure_custom_mix(initiator_channel_ID, callee_interpreter_channel_ID, −12, FALSE, FALSE) command may cause the configurable teleconference bridge to route incoming audio from the initiator to the callee's interpreter, while leaving the audio amplitude unchanged. The channel may not (first “false” parameter) be muted by default and the initiator interpreter may not (second “false” parameter) be able to modify the channel's volume via the app.

Many other mix configurations are also possible; e.g. as above but with different channel ID's.

Another command that may be used is set_custom_mix_volume(channel_ID, volume_factor). This command typically follows the same path as configure_custom_mix_command i.e. app server 10 to telephony server 20, then to the bridge of FIG. 2. parameters may be:

channel_ID: the unique identifier for the audio destination channel.
volume_factor: the new denominator to be used to reduce volume of the audio samples with that destination channel, e.g. as with the configure_custom_mix_command.

Generally, the term “bridge” is used herein to include any functionality within a service provider or carrier that connects multiple callers together and monitors the conference call session.

It is appreciated that a wide variety of conventional bridges are known which may be used to electronically balance lines so that each caller can hear and speak to all the others, no matter how many people hop on or off the call. Typically, a teleconference bridge is a system which facilitates termination of a plurality e.g. 3 or more, audio and video connections at a common destination. The bridge is typically operative for receiving inbound signals from a local telephone switch and confirming those signals with an outbound return signal. Typically, the teleconference bridge includes a server (bridge server) that processes inbound signals received over local phone switches and also processes outbound signals made using the local switch, e.g. conventionally as for any other type of telephone call. The server is typically operative to send and receive multiple audio and/or video signals using trunks, e.g. lines that are each uniquely identified within the server. Once a connection has been established, a call may be routed into a particular conference, by means of computers connected to the server. Once plural callers are routed to “their” conference, they converse with each other. In the past, human conference call operators dialed out to each attendee and manually brought the connection into a given conference session. Conference attendees may dial in using a toll or toll-free number. A suitable identifier e.g. numeric pass code may be pre-sent to assignees by a conference organizing party, to enable attendees to subsequently enter “their” conference without aid from a human operator. In video conferencing, the teleconference bridge establishes both audio connections and visual connections, to conference rooms pre-certified to receive a particular video signal. State of the art teleconference bridge designs make it possible for an audio conference to continue even if the video feed is temporarily inoperative. In web conferences. Internet connectivity is used to create a meeting with voice and graphics components such as but not limited to documents, spreadsheets, and slide presentations. Signaling may occur via the Internet, in conjunction with a teleconference bridge operative for receiving signals converted at the local phone switch and routed to the bridge for processing by the bridge's server e.g. as described above.

If a legacy telephony server with a conferencing bridge application is employed, e.g. Asterisk, the conferencing bridge application may be suitably developed to provide the volume and muting logic described herein. Inputs to the logic are provided to the telephony server by the application server 10, and the telephony server's audio mixing functionality mixes the signals for each teleconference communicant, governed by the conferencing bridge application's volume and muting logic which logic may apply differentially to each communicant (e.g. divide volume by volume factor for some communicants and not others, mute certain channels for some communicants and not others). As described with reference to FIG. 1, the SIP trunk 30 converts the output of the telephony server into signals useable by conventional PSTN telephone equipment, thereby resulting in audio data reaching each communicant at reduced volume if and for whom appropriate, and/or with appropriate channel/s muted, if and for whom appropriate.

It is appreciated that instead of muting a channel, the channel can simply not be established at all, however since opening and replacing channels are typically costly operations, all possibly needed channels are initially opened, as described herein, only subsequently, channels are eliminated, from the end-users' point of view, simply by toggling a “channel muted” flag in the conferencing bridge.

Other modules may be provided e.g. all or any subset of the following:

music on hold-plays music for users on hold. No inputs need be provided, output comprises music which may be streamed to the users via the audio streaming module.

IVR (Interactive Voice Responses)—inputs may comprise commands from telephony server scripts or commands from the app server 10, outputs may comprise voice prompts played via the audio streaming module.

Audio Streaming module—sends and receives audio packets.

App server call state machine—manages pre-defined call states in the App server. Example call states may include all or any subset of the following:

CallStateCallingInterpreters—a state after the system calls the interpreters while waiting for their response.

CallStateConnected—a state for a call after all the users are connected and transferred to the bridge.

Call StateDisconnecting—a state after receiving a disconnection event from one of the users, and while the system disconnects the other users.

CallStateInitial—default call state after the call object is created.

CallStateWaitingCalleeAnswer—state of the call after the interpreters and the initiator are connected and are waiting for the callee to answer.

CallStatePlayingUserAbortPrompts—the state of the call after a user has cancelled a scheduled call, while abort prompts are being played to the interpreters.

CallStateRedirectingToConference—state of the call after all the users are connected, while redirecting all users to the bridge.

CallStateWaitingInitiatorAnswer—call state when dialing a user using an external phone (office phone for example).

CallStateWaitingInitiatorCall—call state when waiting for a teleconference initiator to press the “dial” button on his app.

The PBX state machine of FIG. 3 may be operative to send signaling requests and/or responses to the telephony provider 30 of FIG. 1 and/or commands to the audio streaming module (start audio, stop audio, hold, resume, change IP, change voice codec, etc).

FIGS. 4a-4c, taken together, form a simplified flow chart illustration of a method for scheduling or reserving a teleconference call in accordance with certain embodiments. The method of FIGS. 4a-4c may include some or all of the following operations, suitably ordered e.g. as shown:

Operation 410: The user opens the app, selects a date, at least one communicant's contact number, and a date and time for the call. The user may select one or two interpreters to overcome a single language barrier (e.g. a pair of communicants conversant respectively in Chinese and Japanese, depending on whether one of the sides can speak both languages or on whether one side's accent is understandable to the other, or on cost considerations, since one interpreter can translate all—both Chinese to Japanese and vice versa—or, for a better user experience, 2 separate interpreters may be engaged for the 2 respective interpretation directions. The system may enable the user to add specific definitions for interpreter skills including but not limited to language proficiency. For example, a lawyer may ask for an interpreter who is familiar with legal terms, an engineer may ask for an interpreter with technical background, etc. The user may also select which of her or his phones s/he wants to use to take the call in (e.g. cell phone, office, home).

Operation 420: A call request is sent to the application server 10 which selects suitable interpreters for the call, e.g. from the database of FIG. 1, according to the spoken languages and the specific requests from the user.

Operation 430: A push notification message (or sms, email or other notification alternative, generally references herein to push notification are not intended to be limiting) is sent to all interpreters or all interpreters found suitable in operation 420. For example, when the interpreter opens his app 50 a popup message may appear which asks him if he wants to take the call. The first interpreter who responds to the message is typically assigned to the call.

Operation 440: After the call is set up the user may ask to change the call parameters (such as time, contact, languages). If he does so, an update request is sent to the application server which then determines if it is necessary to cancel the assignments for the interpreters or to assign new interpreters, e.g. via new push notification message/s.

Operation 450: 30 minutes (say) before the call, the interpreters may be reminded via a local notification that they have a call. And/or, 10 minutes (say) before the call a local notification pops up on the user phone reminding him that he has a call. The system may enable the user to click on the pop-up to approve or cancel the call.

Operation 470: The application server 10 typically samples the database periodically for calls which are to be started. When a call is to be started (e.g. a few minutes before the time the conference-initiating user (initiator) requested) application server 10 typically sends a request to the telephony server which causes telephony server 20 to initiate a call with the interpreter(s) via the telephony provider 30. When an interpreter picks up the phone he can typically hear a prompt indicating which language he should translate from and the language he should translate to. After the prompt has been presented, the interpreter may listen to music until the user initiates the call.

Operation 480: When call time arrives, the user gets another local notification saying that he has a call. When the user clicks on the notification or opens the app 60 he can press a button (say) to initiate a call.

Operation 490: If the user selected to take the call on his smartphone, a “start smartphone call” http request may be sent to the server. The server may allocate an inbound access number back to the app 60, and when the app receives the number an outbound call is initiated via the smartphone's dialer app to the received access number.

Otherwise, the server may call the number the user requested when setting up the call (home, office, etc).

Operation 500: The application server 10 initiates a call with the caller via the telephony server 20, and the IP telephony provider 30.

Operation 510: When the user's call is connected, the server calls the callee. If the callee is busy or does not answer, the interpreters may be kept on the line and the initiator may be disconnected; alternatively, any other suitable logic may be implemented.

Operation 520: When the callee answers, the application server 10 typically redirects all the participants to the configurable teleconference bridge in the telephony server of FIG. 3, including establishing some or all of the following channels:

Channel 520a. A channel from the initiator's interpreter to the initiator

Channel 520b. A channel from the callee's interpreter to the callee

Channel 520c. A channel from the initiator to the callee (low output level, can be muted by the callee)

Channel 520d. A channel from the callee to the initiator (low output level, can be muted by the initiator)

Channel 520e. A channel from the callee to the initiator's interpreter

Channel 520f. A channel from the initiator to the initiator's interpreter (low output level, can be muted by the initiator's interpreter as a system default or in advance as a system-stored interpreter preference or in real time;

Channel 520g. A channel from the initiator to the callee's interpreter

Channel 520h. A channel from the callee to the callee's interpreter (low output level, can be muted by the callee's interpreter). It is appreciated that any selection of voices to be heard and/or determination of volume at which voices are heard may, according to certain embodiments, be a system default or may be done in advance, in view of a communicant preference stored e.g. in the database of FIG. 1, or may occur in real time, responsive e.g. to a communicant's input provided via app 50 or 60. 530: Volume changes to the above channels e.g. during the teleconference may be controlled via the apps (typically in addition to conventional volume control via each communicant's phone).

Operation 540: When any participant disconnects, the telephony server gets a disconnection event, and notifies the application server. The application server then disconnects all the other participants of the call.

Operation 550: The user app samples the call state via http every few seconds. If the call status is “disconnected” it pops up a message to the user asking him if he wants to redial or not. If the user chooses to redial, an http message is sent to the app server, and the app server 10 starts the whole process again e.g. returns to operation 430.

Operation 570: upon termination of the call, a feedback screen is displayed to enable participants or all communicants to rate teleconference quality indicators such as but not limited to call smoothness and/or interpreter quality.

Referring back to operations 520, 530:

More generally, it is appreciated that muting may be requested in real time during teleconference e.g. via app 50 or 60; alternatively or in addition, muting may be requested in advance by individual interpreter/user e.g. if an interpreter or user predefines, e.g. via his app 50 or 60, his or her interpreter's muting preference for a specific conference. For example, for a particular conference and/or for a particular participant, it may or may not be important for a participant to hear another participant speaking in a language he does not understand. And/or, for example for a particular conference and/or for a particular interpreter or participant, it may or may not be important for an interpreter to hear a participant he or she is not responsible for translating so as to provide context for utterances he or she is responsible for translating, such as questions put to a participant where the translator is responsible for translating the answer to the question, not the question itself. Muting may be a system default for all interpreters or for certain subcategories thereof.

Similarly, volume change may be requested in real time during teleconference e.g. via app 50 or 60; alternatively or in addition, reduced volume level may be requested in advance by individual interpreter/caller e.g. by predefining via app 50 or 60. Reduced volume level may be a system default for all interpreters or for certain subcategories thereof.

Any suitable technology may be employed to physically configure the teleconference so as to conform to the proper muting and volume requirements whether system-configured or user-configured. For example, to provide a channel 520c from the initiator to the callee at low output level, which can be muted by the callee, for a particular teleconference call, the following implementation may be employed:

When the call is connected, the app server 10 decides whether a channel has to be configured. If so, app server 10 may send a suitable command e.g. a configure_custom_mix command to the telephony server using the Asterisk Java module. The command typically contains some or all of the following parameters: source channel ID (the initiator's channel in the example of channel 520c); destination channel ID (the callee's channel in the example of channel 520c); volume decrease factor if volume control is implemented using a multiplicative factor; whether the default is that the channel should be muted/not muted, and a “volume peer” parameter.

The “volume peer” parameter is useful if it is desired to simplify the user interface by providing only a single volume control dial (or other control) for manipulation by an individual communicant, using her or his app 50 or 60, during the teleconference. Typically, all communicants are heard at a similar level L, which may of course be adjusted by each communicant using his or her phone, except for specific communicants A which are heard by certain other communicants B at a volume level which is controllable, relative to the volume level L, by communicants A.

If this is the case, the “volume peer” parameter determines which peer's (fellow teleconference communicant's) volume is modified responsive to the individual communicant's manipulation of the single volume control dial. For example, if the individual communicant is an interpreter, her or his volume peer/s may be system-defined as the participants who she or he is not responsible for translating. Or, if the individual communicant is a participant and not an interpreter, her or his volume peer/s may be system-defined as the fellow participant/s whose language of discourse is not known by the individual communicant. In the first instance, the interpreter increases the volume (e.g. by a certain factor relative to level L), using the single volume control dial, e.g. if s/he wants to hear context utterances even if s/he is not translating them, and decreases the volume (perhaps to 0) otherwise. In the second instance, the participant increases the volume (e.g. by a certain factor relative to level L), using the single volume control dial, e.g. if s/he wants to detect affect or intonation in a fellow participant's foreign language utterances even if s/he does not understand the content of these utterances, and decreases the volume (perhaps to 0) otherwise.

According to certain embodiments, the volume peer parameter may govern whether a subsequent volume change request on this destination channel will change the volume of the specified source channel. Example: when opening the channel from the initiator (source channel) to the callee (destination channel), volume peer is set to true. When a volume change request is received from the callee, the bridge is programmed to change to volume of the initiator on packets sent to the callee. On the channel from the callee's interpreter to the callee, volume peer is set to false, which means the callee cannot control the volume he hears the interpreter in.

Upon receipt of a volume change request e.g. as above from the application server 10, telephony server 20 redirects audio from the source channel to the destination channel, while dividing each audio sample by the requested factor. Whenever a voice packet is received from the source channel via the streaming module, and the channel pair is not muted, the telephony server may divide the value of the audio sample by the factor and sends on to the destination channel. Then the telephony server sends the new sample value to the target participant.

When a user/interpreter requests mute during a call, an http request may be sent from his app to the app server 10. The app server 10 checks the call state to see if the state is valid, and if so sends a mute/unmute request to the bridge e.g. via the Asterisk Java module of FIG. 2. Typically, the configurable teleconference bridge of FIG. 3 receives this message and responsively toggles the muted flag.

Similarly, for volume change, a http request containing the volume level may be sent from the user or interpreter via their apps. Responsively, a request may be sent by the app server 10 e.g. via the Asterisk Java module via the telephony server to the bridge. Responsive to receiving this message, the bridge makes a suitable change in the volume factor.

Suitable system defaults may be defined for muting and/or for volume. For example, according to certain embodiments, interpreters hear only the person they translate from, and users hear each other, or other users with whom they have no common language, with a default decrease factor of (say) 12.

This or other implementations may also be employed, mutatis mutandis, to obtain proper muteness and/or volume configurations, whether system-configured or user-configured, for channels 520d, 520f, 520h and so forth.

“Immediate Call” flow is provided, typically in addition to the flow of FIGS. 4a-4c, according to certain embodiments. This flow or mode is employed when a user wants to call “now” e.g. to reserve a conference on an immediate basis. To facilitate this, some or all of the following may be provided:

a. When an interpreter opens his app he may mark himself as “available for the next M minutes”. This updates the server via http, that this interpreter is committed to be available for providing service to “immediate” i.e. spontaneously reserved teleconferences occurring within say the next M=120 minutes; after this period of time the application server may send the interpreter a notification inquiring whether he will continue to be available to serve spontaneously reserved teleconferences for the next M′ minutes (e.g. 120 minutes).
b. A user opens his app and schedules a call for “now”.
c. The server receives the request, and searches for “available” interpreters which match the languages and tags, if any, which the user has entered. If such interpreters are found, the request for an immediate call is granted, for example the server may call these interpreters, play prompts and put these interpreters on hold. Then, after the interpreters are on the line, the server typically sends an electronic e.g. push notification to the initiator indicating that the interpreters are on the line and that the initiator may now call.
d. When the user opens the app again he may press a “call” button and the call is connected. From this point on, this call may be identical to a scheduled call (a call reserved in advance rather than on an immediate basis).

The illustrated embodiment is intended to be exemplary rather than limiting, many alternative implementations are described throughout. To give some further examples, the server/s of FIG. 1 need not be provided on a cloud. Also, server/s may be run in a static rather than elastic environment e.g. using a conventional static environment provider such as 012, rackspace, godaddy rather than (say) Amazon EC2. The application server may be written in any suitable language such as C#, python, java or c++. A direct connection to the PSTN may be provided, rather than connecting via an IP telephony provider e.g. by installing dedicated telephony hardware in the telephony servers, and/or by associating a Voice over IP gateway with the telephony server 20. Mobile web sites may replace the cellular apps 60, 50 used by the teleconference participants and users. Client and interpreter applications may be written using native code, cordova/phonegap or any other code suitable for (say) android, iphone, and/or windows.

User registration may be omitted altogether. Notification technology used to contact users and/or interpreters may be, say, email or sms rather than push notification. Local notifications or email or SMS or any other suitable electronic notification may be used for meeting reminders; notifications may be sent from the server side or may be generated by the phone to prevent delays. Database triggers may be employed rather than sampling call time to start scheduled calls on the server side (e.g. by polling every minute). The interpreter/s may be called at a different point in the sequence e.g. only when the user presses the call button. Channels may be established earlier e.g. as soon as even a single communicant has been called, rather than only when all communicants have been called. A user may be required to always receive calls rather than enabling her or him to make an outbound call from his smartphone. If a user wants an inbound call s/he can use any phone he wants as an external number, including but not limited to her or his own phone. Rather than enabling each participant to hear another participant in the background so as to get information other than speech content such as intonation, tone, delays, the bridge can enable each participant or at least one participant to hear only one other participant: For example, the initiator would hear only his interpreter, the callee would hear only his interpreter, and each interpreter would hear only the participant his is translating from.

Disconnections may be handled differently e.g. by reconnecting interpreters if they are disconnected before the end of the call while putting the other users on hold.

Immediate call flow could be omitted and instead, teleconferences scheduled for now (immediately) may be handled the same as those being scheduled for a later time.

A protocol other than http may be used for communication with the apps. The entire application server may be locked each time a locking operation is performed; rather than, say, locking only call objects and no other object. A db interface (e.g. jdbc), may be employed to make the code faster. An SMS gateway functionality other than twilio may be employed. Asynchronous code need not be implemented using Spring. A new object may be allocated for each state in each call rather than using singletons.

The scope of the invention is intended to include any platform enabling a plurality of participants to interact efficiently via one or more interpreters. The platform may or may not be used to build up a virtual community or network or repository of interpreters. The system may for example support a BYOI (Bring Your Own Interpreter) option which allows users to provide their own interpreters while gaining from the system the ability to make a teleconference call with suitable volume control and/or muting as described herein. For example, the users' own interpreters may be recognized by the system as interpreters for the purpose of the specific conference and the relevant operations in FIGS. 4a-4c may be employed.

A particular advantage of certain embodiments is that interpreters can translate without being distracted by sound channels irrelevant to their work.

Another particular advantage of certain embodiments is that an individual teleconference participant can hear a simultaneous translation of another participant superimposed over the other participant's voice, thereby to enable the individual teleconference participant to perceive in real time both the content conveyed by the other participant and simultaneously the affect conveyed by the other participant.

It is appreciated that terminology such as “mandatory”, “required”, “need” and “must” refer to implementation choices made within the context of a particular implementation or application described herewithin for clarity and are not intended to be limiting, since in an alternative implantation, the same elements might be defined as not mandatory and not required or might even be eliminated altogether.

It is appreciated that software components of the present invention including programs and data may, if desired, be implemented in ROM (read only memory) form including CD-ROMs, EPROMs and EEPROMs, or may be stored in any other suitable typically non-transitory computer-readable medium such as but not limited to disks of various kinds, cards of various kinds and RAMs. Components described herein as software may, alternatively, be implemented wholly or partly in hardware and/or firmware, if desired, using conventional techniques, and vice-versa. Each module or component may be centralized in a single location or distributed over several locations.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. The invention shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein, and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of the present invention is not limited to structures and functions specifically described herein and is also intended to include devices which have the capacity to yield a structure, or perform a function, described herein, such that even though users of the device may not use the capacity, they are, if they so desire, able to modify the device to obtain the structure or function.

Features of the present invention, including operations, which are described in the context of separate embodiments may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly, although not limited to, those described in the Background section or in publications mentioned therein.

Conversely, features of the invention, including operations, which are described for brevity in the context of a single embodiment or in a certain order may be provided separately or in any suitable subcombination, including with features known in the art (particularly although not limited to those described in the Background section or in publications mentioned therein) or in a different order. “e.g.” is used herein in the sense of a specific example which is not intended to be limiting. Each method may comprise some or all of the operations illustrated or described, suitably ordered e.g. as illustrated or described herein.

Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS. Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation and is not intended to be limiting.

1. A conferencing system which provides a service to conference participants, the system comprising:
a teleconference bridge server operative for controlling a telephony provider to facilitate teleconferences between previously defined communicants; and
an application server including:
a conference definition environment operative to allow conference initiators to define at least one requested conference's time, participants and need, if any, for at least one conference service provider to provide at least one conference service to at least one of said participants at said time; and
a communication interface including:
electronic notification functionality operative to send electronic notification to at least a portion of a population of service providers of at least one desired conference's time and need for at least one conference service provider, as defined via said environment, and
at least one processor operative to receive at least one message from at least one individual service provider in the population of service providers, each message confirming intention of the individual service provider to provide said service for said individual conference, and to command the telephony provider, via the teleconference bridge server, to add the individual service provider to the individual conference by establishing at least one audio channel between the individual service provider and at least one of said participants.

2. A system according to claim 1 wherein said conference comprises a teleconference.

3. A system according to claim 1 wherein said conference comprises a face to face meeting and wherein there is no option for communicants to hear other communicants via telephone since communicants hear one another directly.

4. A system according to claim 1 wherein said service comprises translation from a language which one participant is registered to have knowledge of, to a language which another participant is registered to have knowledge of.

5. A system according to claim 1 wherein said electronic notification functionality comprises push notification functionality.

6. A system according to claim 1 wherein the processor is configured to command the teleconference bridge server, as a default, to mute at least one channel to at least one interpreter translating a specific teleconference participant, other than a channel from the specific teleconference participant to the interpreter, which is not muted.

7. A system according to claim 1 wherein the processor is configured to command the teleconference bridge server, as a default, to reduce volume for at least one channel from a first teleconference participant to a second, if the first is being translated for the second.

8. A system according to claim 1 wherein the processor is configured to command the teleconference bridge server, as a default, to mute at least one channel from at least one interpreter to at least one specific teleconference participant, if the interpreter is translating from a language said specific teleconference participant understands.

9. A system according to claim 1 wherein the system has teleconference initiator-selectable modes including a normal teleconference reservation mode for defining teleconferences to be held at a future time, and an immediate call mode for defining teleconferences to be held immediately, and wherein, when the system is in normal mode, the application server is configured such that any requested teleconference is accepted unless there is an unusual circumstance requiring the requested teleconference to be denied; whereas when the system is in immediate call mode, the application server is configured such that any requested teleconference is accepted only if at least one individual service provider from the population of service providers responds to said electronic notification within a time-out period.

10. A system according to claim 1 wherein the communication interface is configured to receive from at least one individual service provider in the population of service providers, an availability indication indicating that the service provider is currently available and wherein the system has teleconference initiator-selectable modes including an immediate call mode for defining teleconferences to be held immediately, and wherein, when the system is in immediate call mode, the application server is configured to send said electronic notification only to those specific service providers within the population of service providers which have previously provided an availability indication which is still in force.

11. A system according to claim 1 wherein the electronic notification functionality is operative to send electronic notification only to service providers capable of fulfilling said need, thereby to ensure that each service provider added to the individual teleconference is capable of fulfilling at least one need of at least one participant thereof.

12. A system according to claim 1 wherein said service providers comprise interpreters and wherein said application server is configured to receive, from at least one of said initiators defining at least one requested teleconference's time, participants and need, language proficiency data for participants of said teleconference and wherein the electronic notification functionality is operative to send electronic notification only to interpreters capable of translating between languages which, according to said language proficiency data, are known by some of said participants, and not by others.

13. A system according to claim 1 wherein said application server is configured to receive, from at least one of said initiators defining at least one requested teleconference's time, participants and need, an indication of how many service providers s/he wishes to engage for said requested teleconference.

14. A system according to claim 13 wherein said service providers comprise interpreters and wherein at least one interpreter between first and second languages known by some participants and not others is required for said requested teleconference and wherein said application server is configured to receive, from at least one of said initiators defining at least one requested teleconference's time, participants and need, an indication of whether s/he wishes to engage for said requested teleconference:
only a single interpreter proficient in said first and second languages to interpret from said first language to said second, and vice versa, during said requested teleconference, or
a pair of interpreters each proficient in said first and second languages, the pair including a first interpreter to interpret from said first language to said second language during said requested teleconference and a second interpreter to interpret from said second language to said first during said requested teleconference.

15. A system according to claim 4 wherein said service providers comprise interpreters and also comprising a database storing contact particulars and language proficiencies of registered service providers.

16. A system according to claim 15 and also comprising accumulated quality indicators for at least some of said service providers, quantifying quality of service provided to date by said interpreters.

17. A system according to claim 1 and wherein the application server defines, for at least one pair of first and second communicants associated with at least one teleconference, whether or not the first communicant hears the second communicant.

18. A system according to claim 1 and wherein the application server defines, for at least one pair of first and second communicants associated with at least one teleconference, the volume at which the first communicant hears the second communicant.

19. A system according to claim 15 wherein the application server selects, from said database, appropriate registered service providers whose language proficiencies correspond to at least one conference's need for service and wherein said electronic notification functionality is operative to send said electronic notification to said appropriate registered service providers.

20. A conferencing method which provides a service to conference participants, the method comprising:
Employing a teleconference bridge server for controlling a telephony provider to facilitate teleconferences between previously defined communicants; and
Providing an application server including:
a conference definition environment operative to allow conference initiators to define at least one requested conference's time, participants and need, if any, for at least one conference service provider to provide at least one conference service to at least one of said participants at said time, and
a communication interface including:
electronic notification functionality operative to send electronic notification to at least a portion of a population of service providers of at least one desired conference's time and need for at least one conference service provider, as defined via said environment; and
at least one processor operative to receive at least one message from at least one individual service provider in the population of service providers, each message confirming intention of the individual service provider to provide said service for said individual conference, and to command the telephony provider, via the teleconference bridge server, to add the individual service provider to the individual conference by establishing at least one audio channel between the individual service provider and at least one of said participants.

21. A computer program product, comprising a non-transitory tangible computer readable medium having computer readable program code embodied therein, said computer readable program code adapted to be executed to implement a conferencing method which provides a service to conference participants, the method comprising:
Employing a teleconference bridge server for controlling a telephony provider to facilitate teleconferences between previously defined communicants; and
Providing an application server including:
a conference definition environment operative to allow conference initiators to define at least one requested conference's time, participants and need, if any, for at least one conference service provider to provide at least one conference service to at least one of said participants at said time; and
a communication interface including:
electronic notification functionality operative to send electronic notification to at least a portion of a population of service providers of at least one desired conference's time and need for at least one conference service provider, as defined via said environment; and
at least one processor operative to receive at least one message from at least one individual service provider in the population of service providers, each message confirming intention of the individual service provider to provide said service for said individual conference, and to command the telephony provider, via the teleconference bridge server, to add the individual service provider to the individual conference by establishing at least one audio channel between the individual service provider and at least one of said participants.
